(19) United States
(12) Patent Application Publication
(10) Pub. No.: US 2002/0125236 A1
(43) Pub. Date: Sep. 12, 2002

(54) Coating of selected titanium oxides for improved weld penetration for iron, nickel, chromium and cobalt alloys

(76) Inventors: Vladimir Moravek, Waterdown (CA); Paul Lowden, Cambridge (CA); Joseph Liburdi, Dundas (CA)

Correspondence Address: Frederick F. Calvetti, Smith, Gambrell & Russell, 1850 M Street, N.W., Washington, DC, 20036, US

(21) Appl. No.: 10/092,757

(22) Filed: Mar. 8, 2002

Related U.S. Application Data
(60) Provisional application No. 60/273,954, filed on Mar. 8, 2001.

(51) Int. Cl. B23K 9/235

(52) U.S. Cl. 219/137 WM

(57) ABSTRACT

The present invention provides a method and coating for improved weld penetration, reduced weld current, and/or reduced bead width during an electric arc welding process. The coating of the present invention comprises selected oxides of titanium and amorphous titanium sub oxide in a suitable carrier.

### FIELD OF THE INVENTION

Existing arc welding processes for welding stainless steel has presented welding depth penetration problems that seriously affect the quality of the resulting welds. Limitations in depth penetration produced by the arc welding process can result in imperfect welds. Variations in the weld penetration depth may also result when different heats are used to weld pieces of stainless steel.

### BACKGROUND OF THE INVENTION

It is known in the prior art that various coatings and surfactants may be applied to the surface of the stainless steel to be welded by the gas tungsten arc welding process to address weld penetration problems. For instance, the use of flux to increase the weld penetration in stainless steel is described in O. E. Ostroviski, “The Effect of Activating Fluxes on the Penetration of the Welding Arc and the Energy Concentration in the Anode Spot,” Svar. Proiz, No. 3, pp. 3-4 (1997). Ostroviski discloses a flux comprised of a variety of compounds providing some advantages; however, corrosive and toxic fluorine compounds are present. Further, it is difficult to obtain a uniform coating of the flux on the weld surface where the flux is being applied and additional problems in obtaining adequate adhesion of the coating to the weld surface typically result.

U.S. Pat. No. 3,584,187 to Majetich et al., discloses the use of a suitable oxide coating to improve the weldability of stainless steels. Majetich et al. teaches a coating of at least an oxide of iron, chromium, silicon, titanium, manganese, nickel, cobalt, molybdenum, and calcium mixed with a volatile liquid carrier to form a slurry applied to the stainless steel surface.

Although Majetich et al.'s coating promotes weld penetration, the coating components utilized are potentially toxic. Further, Majetich et al. does not disclose the use of selected oxides of titanium in an improved coating.

U.S. Pat. No. 5,804,792 to Paskell discloses a welding flux for improved penetration during the gas tungsten arc welding process of a selected substrate, such as stainless steel. The costing comprises Ti or TiO2 in combination with oxides of chromium and silicon dioxide mixed with a selected carrier such as methyl-ethyl ketone. This flux is suited to only a limited range of stainless steels (300 series) and the chromium and silicon dioxide components tend to be toxic. LO Paskell further does not teach the use of selected oxides of titanium in an improved coating.

Accordingly, there is a need for an easily prepared, less toxic coating that improves the weld penetration of stainless steel. The present invention answers this need by providing an improved welding coating comprised of selected titanium oxides and sub oxide of titanium exhibiting improved weld penetration over prior art coatings.

### SUMMARY OF THE INVENTION

The present invention provides an improved coating material exhibiting increased weld penetration in welding alloys of nickel, iron, chromium, and cobalt. The improved coating comprises a combination of at least one titanium oxide or titanium sub oxide, depending on the substrate to be welded.

In the preferred embodiment of the invention, the improved coating comprises a predetermined combination of amorphous sub oxide of titanium, TiO, Ti5O9, Ti6O11, and TiO2.

In the preferred embodiment, welding penetration with use of the coating is significantly improved, or, alternatively, welding current is significantly reduced while producing weld penetration equal to that achieved in the absence of the coating. Further, bead width of the resulting weld may be reduced.

An aspect of the present invention is the use of a commercial solvent, such as alcohol, to act as a carrier for brushing or spraying the coating of the present invention on the alloy substrate to form a layer. Preferably, the carrier evaporates leaving the coating layer on the surface of the substrate.

### BRIEF DESCRIPTION OF THE DRAWINGS

FIG. 1 shows a cross-section of a low sulphur stainless steel 304 plate with no welding penetrant material or flux present.

FIG. 2 shows a cross-section of the same plate wherein a commercial welding flux was employed.

FIG. 3 shows a cross-section of a plate having been welded with the weld penetrant material of this invention applied to the surface thereof.

FIG. 4 shows a cross section of a ⅜″ thick IN 718 having been welded with no weld penetrant material applied to the surface thereof.

FIG. 5 shows a cross-section of the same stainless steel plate as shown in FIG. 4 having been welded in the presence of another catalytic coating of this invention.

FIG. 6 shows a ½″ stainless steel plate having various catalytic coatings of this invention applied thereto at four locations before welding took place.

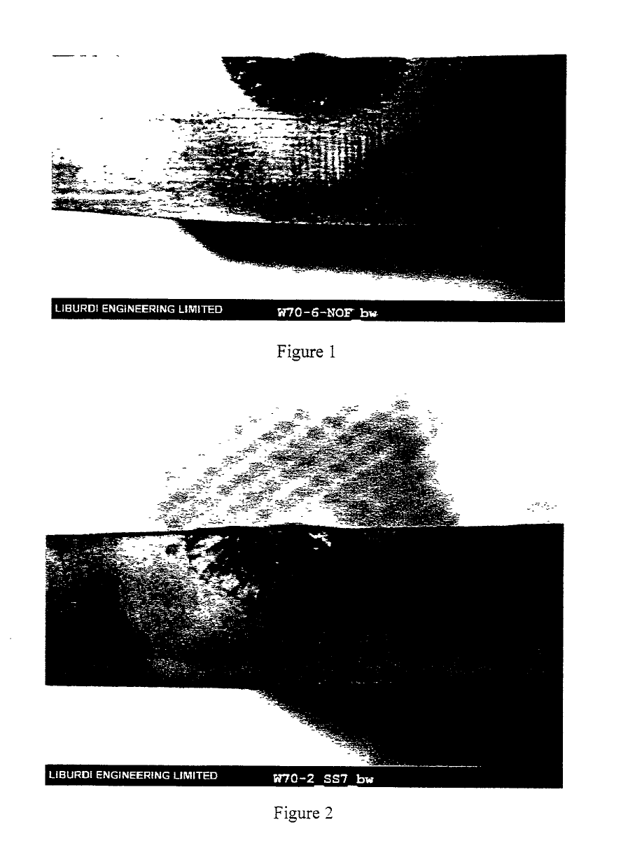

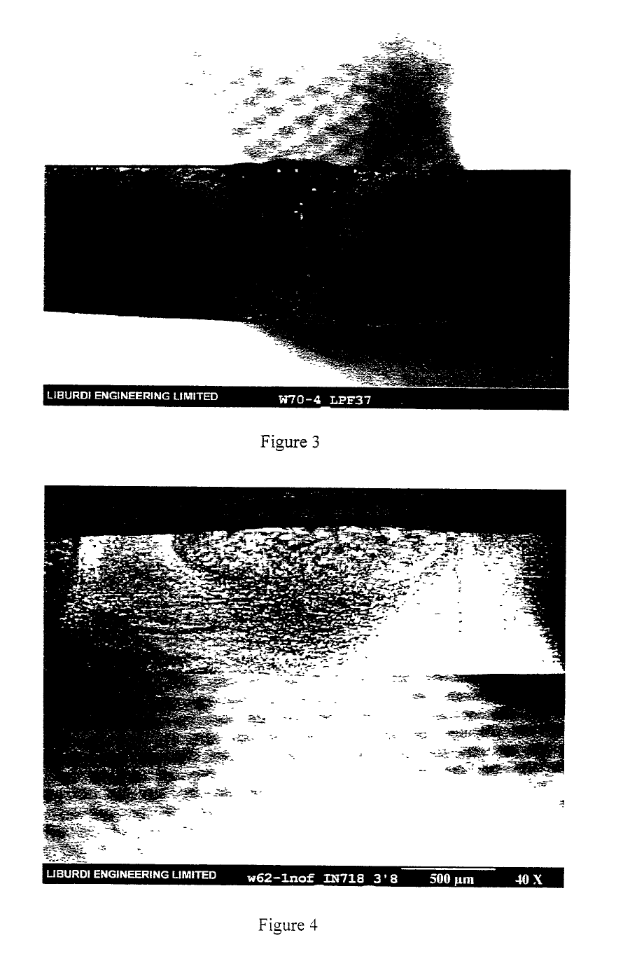

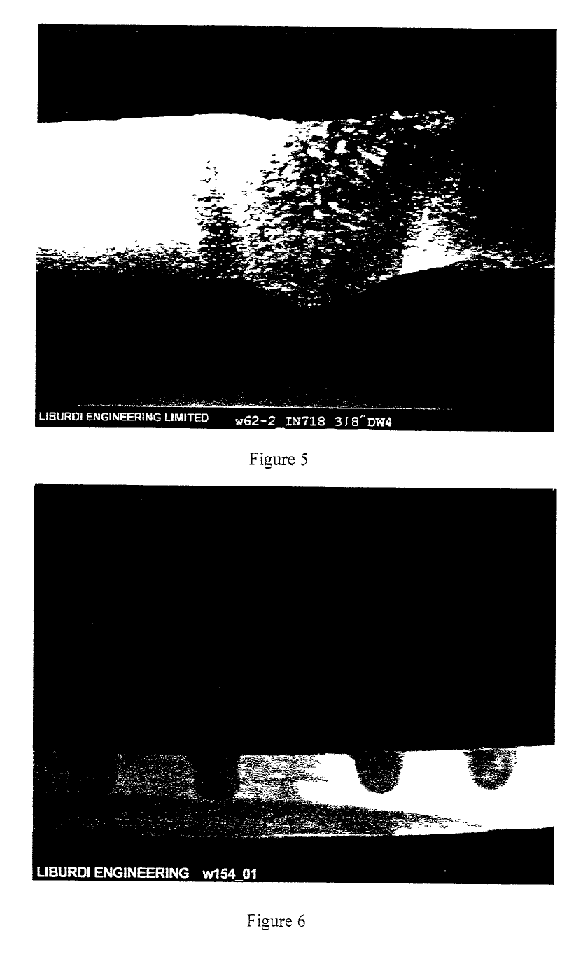

### DETAILED DESCRIPTION OF THE INVENTION

The present invention provides a suitable coating comprised of selected titanium oxides and sub oxide of titanium for improved weld penetration in welding alloys of nickel, iron, chromium, and cobalt. Alternatively, the use of the coating, of the present invention significantly reduces welding current while producing weld penetration equal to that achieved in the absence of the coating. Further, the coating of the present invention also can significantly reduce bead width of the resulting weld.

Preferably, the coating of the present invention comprises a predetermined combination of amorphous sub oxide of titanium, TiO, Ti5O9, Ti6O11, and TiO2. The titanium oxides and sub oxide of titanium of the present invention may be prepared as described in Von Paul Ehrlich, Z Electrochem. V45 No. 5 362 (1939) and Nach F. Halla, Z. ANorg. Allg. Chem. V184 421 (1929). Preferably, a mixture of unstable non-stoichiometric Ti—O compounds is produced by the controlled oxidation of titanium or the controlled reduction of commercially available titanium oxides, such as TiO2, Ti2O3, TiO, etc.

In the preferred embodiment, a commercial grade alcohol provides a satisfactory carrier for the combination of oxides and sub oxide of titanium in the coating of the present invention. Commercial alcohol's that evaporate quickly and leave no residue perform well as carriers for the selected titanium oxides and sub oxide that make up the coating of the present invention.

Preferably, the carrier and selected oxides and sub oxide of titanium are combined in a slurry for brushing or spraying on the substrate of stainless steel, including alloys of nickel, iron. chromium, and cobalt. In the preferred embodiment the gas tungsten arc welding process is used to weld the substrate with the coating of the present invention.

As described in the following examples, the application of coating of the present invention provides improved weld penetration or reduced weld current in the welding process over prior art fluxes.

### EXAMPLE 1

A slurry composition was prepared in accordance with the above description comprised of 15% amorphous sub oxide of titanium, 10% TiO, 20% Ti5O9, 30% Ti6O11, and balance TiO2. The powder was sieved through a 400 mesh screen and mixed with a commercial grade isopropanol and applied to the surface a stainless steel plate. Standard gas tungsten arc welding process was used, and bead penetration was achieved.

### EXAMPLE 2

A slurry composition was prepared in accordance with the above description comprised of 15% amorphous sub oxide of titanium, 10% TiO, 20% Ti5O9, 30% Ti6O11, and balance TiO2. The coating was sieved out in a 400 mesh sieve and mixed with a commercial alcohol and applied to the surface of a ⅜ 718 nickel-based alloy plate. Gas tungsten arc welding process was used with welding current of 250 amperes, arc gap ⅛″, travel speed 1.5″/minute, and tungsten tip angle of 60 degrees. A bead weld penetration depth was achieved.

### EXAMPLE 3A

A slurry composition was prepared in accordance with the above description comprised of 5% amorphous sub oxide of titanium, 5% TiO, 10% Ti5O9, 10% Ti6O11, and 20% TiO2. A ½″ 304 LC steel plate was coated with the slurry composition (alcohol carrier). Gas tungsten arc welding process was used with welding current of 200 amperes arc gap 0.080 (units?), travel speed 1.25″/minute, and tungsten tip angle of (?) degrees. A bead weld penetration depth of was achieved.

### EXAMPLE 3B

The same parameters of Example 3A were utilized with a slurry composition comprising 15% amorphous sub oxide of titanium, 15% TiO, 15% Ti5O9, 20% Ti6O11, and 30% TiO2 (rutile, anatase or brookite). A bead weld penetration depth was achieved.

### EXAMPLE 3C

The same parameters of Example 3A were utilized with a slurry composition comprising 25% amorphous sub oxide of titanium, 10% TiO, 20% Ti5O9, 30% Ti6O11, and balance TiO2. A bead weld penetration depth was achieved.

### EXAMPLE 3D

The same parameters of Example 3A were utilized with a slurry composition comprising 20% amorphous sub oxide of titanium, 15% TiO, 25% Ti5O9, and 40% Ti6O11. A bead weld penetration depth was achieved.

In each of the foregoing examples the weld penetration depth using a coating with sub oxide of titanium exceeded the penetration for a coating of TiO2 alone.

It will be appreciated by those of ordinary skill in the art that in addition to the gas tungsten arc welding process, most electric welding processes will show improved weld penetration using the coating of the present invention.

Further, the description herein has been directed to the application of coatings that are applied to the surface of the substrate, preferably stainless steel, undergoing welding. Those of ordinary skill in the art will appreciate that the coating on the substrate may be applied to a welding electrode used in arc welding operations to improve weld penetration.

While the invention has been described with reference to the structures and methods disclosed, it is not confined to the details set forth, but is intended to cover such modifications or changes as may fall within the scope of the following claims.

What is claimed is:

1. A coating composition for improved weld penetration during an arc welding process comprising amorphous sub oxide of titanium.

2. The composition of claim 1 further comprising at least one oxide of titanium.

3. The composition of claim 2 wherein said at least one oxide of titanium is selected from the group consisting of TiO, Ti5O9, Ti6O11, and TiO2.

4. The composition of claim 3 wherein said composition comprises between 5 to 25% by weight amorphous sub oxide of titanium

5. The composition of claim 4 wherein said at least one oxide of titanium comprises between 5 to 15% by weight TiO.

6. The composition of claim 4 wherein said at least one oxide of titanium comprises between 10 to 25% by weight Ti5O9.

7. The composition of claim 4 wherein said at least one oxide of titanium comprises between 10 to 40% by weight Ti6O11.

8. The composition of claim 4 wherein said at least one oxide of titanium comprises between 5 to 15% by weight TiO, between 10 to 25% by weight Ti5O9, between 10 to 40% by weight Ti6O11.

9. The composition of claim 4 wherein said at least one oxide of titanium further comprises the balance by weight TiO2.

10. The composition of claim 9 further comprising a carrier to form a slurry.

11. The composition of claim 10 wherein said carrier is an alcohol.

12. The composition of claim 11 consisting essentially of by weight 5% amorphous sub oxide of titanium, 5% TiO, 10% Ti5O9, 10% Ti6O11, and 20% TiO2.

13. The composition of claim 11 consisting essentially of by weight 15% amorphous sub oxide of titanium, 15% TiO, 15% Ti5O9, 20% Ti6O11, and 30% TiO2.

14. The composition of claim 11 consisting essentially of by weight 25% amorphous sub oxide of titanium, 10% TiO, 20% Ti5O9, 30% Ti6O11, and balance TiO2.

15. The composition of claim 11 consisting essentially of by weight 20% amorphous sub oxide of titanium, 15% TiO, 25% Ti5O9, and 40% Ti6O11.

16. A method for increasing the weld penetration of a nickel, chromium, iron, or cobalt alloy comprising:
a. cleaning the surface of a nickel, chromium, iron, or cobalt alloy substrate;
b. applying a slurry coating of amorphous titanium sub oxide and carrier to the substrate;
c. allowing said coating to dry by evaporation of the carrier; and
d. welding said substrate with an electric arc.

17. The method according to claim 16 wherein said coating comprises from between 5 to 25% by weight said amorphous titanium sub oxide.

18. The method according to claim 17 wherein said slurry coating further comprises between 5 to 15% by weight TiO, between 10 to 25% by weight TiO9, between 10 to 40% by weight Ti6O11.

19. The method according to claim 18 wherein said coating further comprises TiO2.

20. The method of claim 19 wherein said carrier is alcohol.
